(19) United States
(12) Patent Application Publication
(10) Pub. No.: US 2018/0347191 A1
(43) Pub. Date: Dec. 6, 2018

(54) PREFABRICATED CONCRETE SLAB FLOOR AND METHOD OF FABRICATING THE SAME

(71) Applicant: 9360-4742 Quebec inc., Sherbrooke (CA)

(72) Inventors: Pierre Longpre, Sherbrooke (CA); Olivier Longpre, Sherbrooke (CA)

(21) Appl. No.: 15/611,335

(22) Filed: Jun. 1, 2017

(51) Int. Cl. E04B 5/43; E04B 5/12; E04C 2/28; B28B 1/14; B28B 1/08; B28B 13/06; B28B 23/02

(52) U.S. Cl. CPC E04B 5/43; E04B 5/12; E04C 2/28; B28B 1/14; E04B 2103/04; B28B 13/06; B28B 23/024; E04B 2103/02; B28B 1/08

(57) ABSTRACT

The present invention relates to a composite floor, typically a wood/concrete composite floor. The composite floor comprises a support structure being adapted to be attached to a concrete layer. The support structure comprises a top portion being made of at least one support panel comprising at least one opening through which the concrete layer may flow into the inner portion of the support structure once the top portion of the support structure is being disposed on the top of the concrete layer. The upward flow of the concrete creates at least one anchor point, which, once being harden in the inner portion of the support structure, improves the adhesion between the support panels and the concrete and ensures better mechanical rigidity and resistance of the assembly made of the panels and the concrete.

### FIELD OF THE INVENTION

The present invention generally relates to building construction, particularly floors. More specifically, the present invention relates to a prefabricated concrete slab floor being a composite of concrete and wood and a method of fabricating the same.

### BACKGROUND OF THE INVENTION

Nowadays, different methods are used to prefabricate wood and concrete composite floors aiming at limiting the formation and propagation of cracks. However, these methods present different limitations particularly during the manipulation and the transport of the composite floors due to the use of several anchoring points that weaken the structure.

Conventionally, wood and concrete composite floors, such as the floor disclosed in the PCT patent application published under no. WO 9411589, have been proposed to solve the problem of shearing load transfer between the wood and the concrete. However, such floors require the use of a set of connecting and framing elements such as beams and metal spikes in order to improve the adhesion between the wood and the concrete. Such a method of fabricating composite floors is essentially limited to the fabrication of light composite floors.

Furthermore, some methods for fabricating wood and concrete composite floors require pouring concrete directly on the top of the wood structure. However, these methods become useless once the wood structure comprises openings through which the concrete can easily flow resulting in a non-uniform concrete surface.

Despite the previous suggested methods, there is still a need to improve the process of fabricating wood and concrete composite floors as concrete-wood interactions are not well documented.

### SUMMARY OF THE INVENTION

The shortcomings of the prior art are generally mitigated by providing a prefabricated concrete slab floor and a method of fabricating the same.

In one aspect of the invention, a prefabricated composite floor is provided. The prefabricated composite floor comprises a concrete layer and a support structure adapted to receive the concrete layer, the support structure comprising a top portion comprising at least one attachment mechanism, the attachment mechanism being adapted to rigidly adhere the concrete layer to the support structure.

In one aspect of the invention, the at least one attachment mean is being a reinforcing element, the reinforcing element further attaching the top portion to the support portion. The reinforcing element is being outwardly angled from an outer surface of the top portion.

In another aspect of the invention, the at least one attachment mean is being one or more openings within the top portion of the support structure, each of the one or more openings being adapted to let concrete flows between an outer surface of the top portion and an inner surface of the top portion.

In yet another aspect of the invention, the top portion comprises support panels being adapted to be rigidly attached to the concrete layer; the support panels are being supported by a frame. The support panels are being distributed over the top portion in a way to define slots allowing concrete to flow between into an inner side of the top portion and an outer side of the top portion. The frame is being shaped as a lattice.

In another aspect of the invention, the prefabricated composite floor is being a concrete/wood composite floor.

The present invention also provides a method for manufacturing a prefabricated composite floor. The method comprises pouring a concrete in a mold then dipping a top portion of a support structure into the mold. The support structure comprises at least one attachment mechanism adapted to reinforce adherence of the concrete to the top portion of the support structure. The method further comprises letting the concrete dries for a predetermined duration and unmolding the support structure from the mould.

In another aspect of the invention, the mold comprises an arcuate surface and is adapted to be manufacture different sizes and shape of the composite floor.

In yet another aspect of the invention, the method further comprises attaching support panels to a base frame of the support structure. The support panels comprise at least one opening. The method further comprises anchoring the top portion to the concrete by letting the concrete flows between an inner portion of the top portion and an outer portion of the top portion through the at least one opening.

In a further aspect of the invention, the support panels further comprises at least one reinforcing element. The method further comprises dipping the support structure into the mould to fully submerge the at least one reinforcing element into concrete.

In another aspect of the invention, the method further comprises positioning the support structure over the mould and generating vibration in the concrete within the mould. The method further comprises using a positioning mechanism to unmold the support structure.

In yet another aspect of the invention, the method further comprises reinforcing the support structure prior to turning the support structure then turning upside down the unmolded support structure rigidly attached to the concrete layer.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view illustrating a composite floor being made of an assembly of a support structure and a concrete layer in accordance with the principles of the present invention.

FIG. 2 is a sectional plan view of the composite floor of FIG. 1 showing the adhesion between the support structure and the concrete layer in accordance with the principles of the present invention.

FIG. 3 is a close-up top view of the support structure adapted to prefabricate a concrete slab floor in accordance with the principles of the present invention.

FIG. 4 is a perspective top view of the support structure adapted to manufacture a concrete slab floor in accordance with the principles of the present invention.

FIG. 5 is a perspective bottom view of the support structure of FIG. 4 showing reinforcing elements.

FIG. 5A is a perspective view illustrating a second embodiment of a support structure adapted to manufacture a concrete slab floor in accordance with the principles of the present invention.

FIG. 6 is a perspective view illustrating a preferred embodiment of a mold for manufacturing a concrete slab in accordance with the principles of the present invention.

FIG. 7 is a perspective view illustrating the mold for manufacturing a concrete slab of FIG. 6 comprising additional structural elements in accordance with the principles of the present invention.

FIG. 8 is a perspective view illustrating the step of positioning/removing the support structure on/from the top of a mold for manufacturing a concrete slab in accordance with the principles of the present invention.

FIG. 9 is a bottom view of an inner part of the composite floor showing the adhesion between the support structure and the concrete layer in accordance with the principles of the present invention.

FIG. 10 is a perspective view illustrating the step of rotating upside-down the composite floor of FIG. 7.

FIG. 11 is a perspective view illustrating the composite floor assembled with the support structure and the concrete layer in accordance with the principles of the present invention.

FIG. 12 is a schematic view illustrating a method of manufacturing a prefabricated composite floor in accordance with the principles of the present invention.

### DETAILED DESCRIPTION OF THE PREFERRED EMBODIMENT

A novel prefabricated concrete slab floor and method of fabricating the same will be described hereinafter. Although the invention is described in terms of specific illustrative embodiments, it is to be understood that the embodiments described herein are by way of example only and that the scope of the invention is not intended to be limited thereby.

Throughout the description of the several embodiments of the present invention, reference will be made to various attachment means being adapted to ensure adhesion between a support structure and a concrete layer in order to manufacture a prefabricated composite floor. The support structure comprises at least one attachment mean or mechanism allowing the concrete layer to rigidly adhere to the support structure.

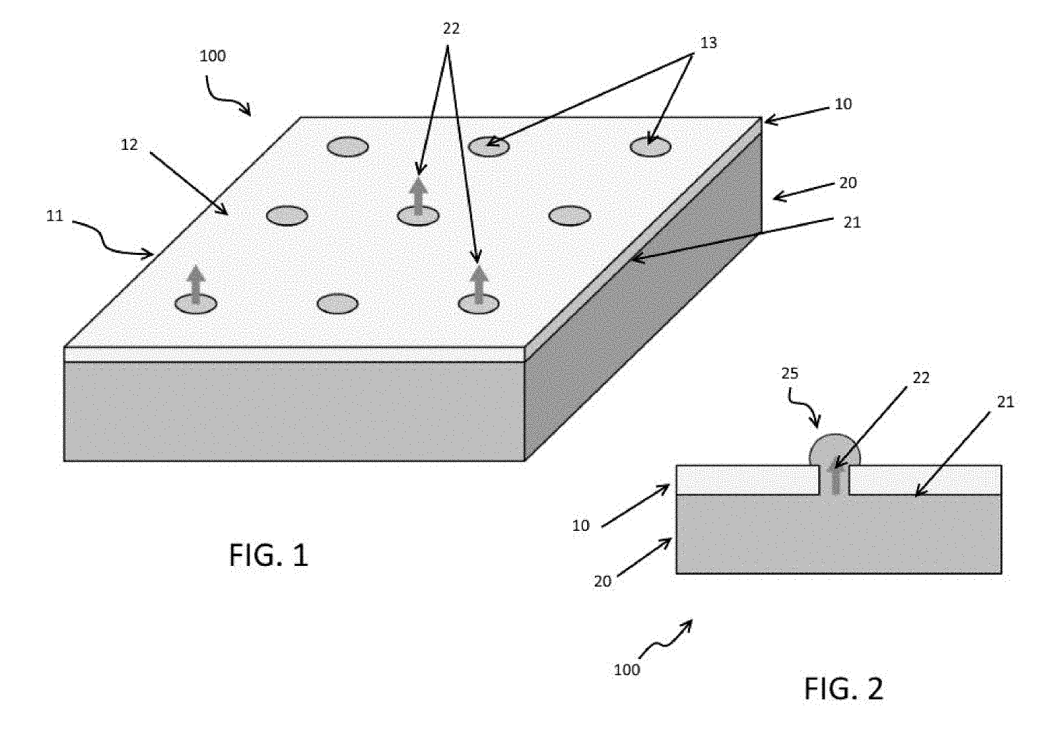

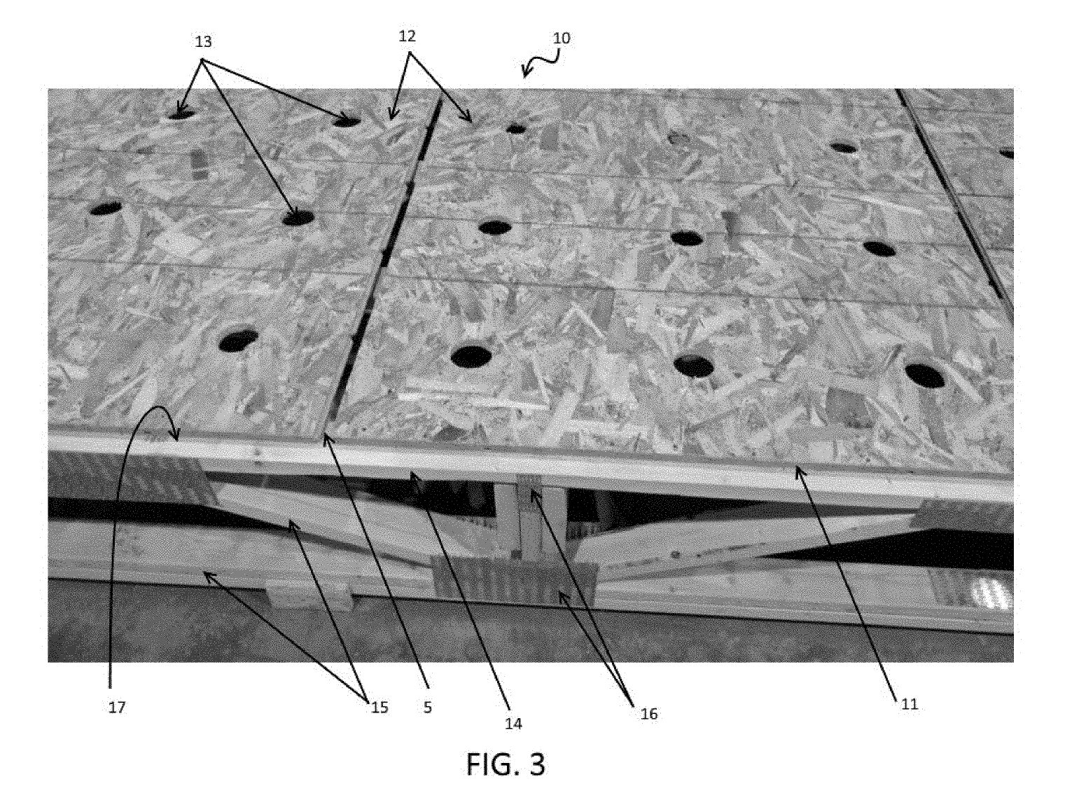

Referring now to FIGS. 1 and 2, a preferred embodiment of a prefabricated composite floor 100 is illustrated. The prefabricated composite floor 100 comprises a support structure 10 being adapted to be attached to a concrete layer 20. The support structure 10 comprises a top portion 11 being made of at least one support panel 12 comprising at least one opening 13 through which the concrete layer 20 may flow to the inner portion of the support structure 10 once the top portion 11 of the support structure 10 is being disposed on the top 21 of the concrete layer 20. In such an embodiment, concrete flowing into the opening or aperture 13 acts as the attachment mean or mechanism.

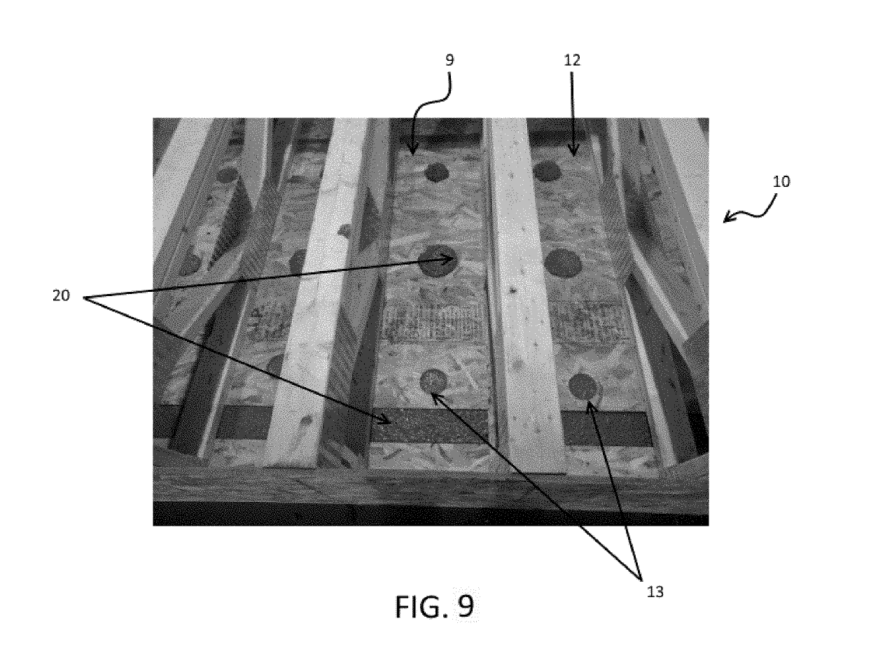

Referring now to FIG. 2, once the top portion 11 of the support structure 10 is being disposed on the top 21 of the concrete layer 20, the weight of the support structure 10 exerts a general downward force which causes upward flow 22 of the concrete layer 20 through openings 13 towards the inner portion 9 of the support structure 10 (See FIG. 9). As the concrete which flew through the opening 13 dries, such upward flow 22 of the concrete creates at least one anchor point 25 between the inner portion of the support structure 10 and the top portion 21 of the support structure 21.

Understandably, the aperture or openings 13 prevent air particles from being trapped between the support panels 12 of the support structure 10 and the concrete 20. The openings 13 aims at allowing the air particles to flow outside of the assembly made of the support panels 12 and the concrete 20. Such outward flow generally aims at improving the adhesion between the support panels 12 and the concrete 20 and aims at ensuring an improved mechanical rigidity and resistance of the assembly made of the panels 12 and the concrete 20.

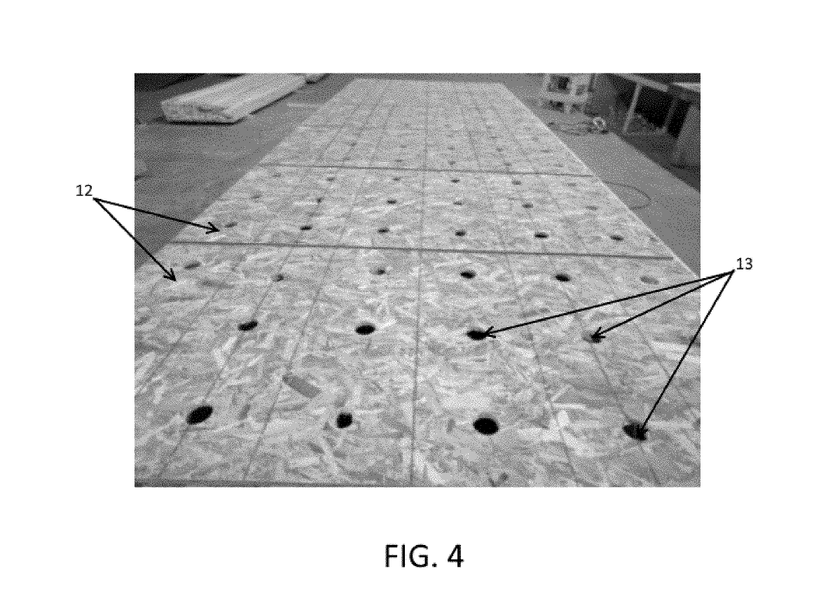

Referring now to FIG. 3, a preferred embodiment of the support structure 10 is shown. The top portion 11 comprises the support panels 12 which is attached to a frame 14. In some embodiments, the frame 14 is made of an assembly of beams 15 and metal spikes 16 attached by the mean of fasteners. Understandably, any other known frame structure 14 may be used without departing from the scope of the present invention.

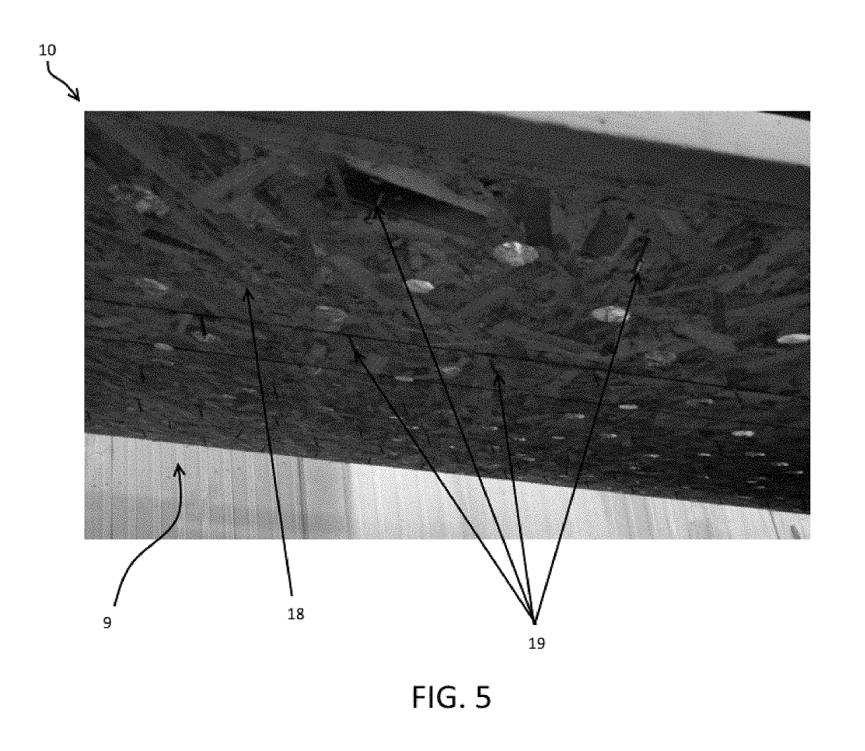

Referring now to FIGS. 3 and 4, the support panels 12 comprises or is formed with the openings 13. In a preferred embodiment, the said openings 13 are distributed on the top portion 11 of the support structure 10 for the concrete layer 20 to adhere to the support structure 10. and to prevent the flow of the concrete through the edges 17 of the top portion 11 of the support structure 10. Understandably, any other known distribution of the openings 13 may be used without departing from the scope of the present invention.

Also, the distribution of the support panels 12 over the top portion 11 and the presence of the openings 13 generally aims at controlling the shape and thickness of the concrete layer 20.

In other embodiments, the support panels 12 may be spaced from each other. In a preferred embodiment, the supports panels 12 are spaced of each other by a distance of approximately one (1) inch and are spaced apart of the edges 17 by a distance of approximately three (3) inches. Such spacing generally define slots 5 (See FIG. 3). The slots 5 may allow the concrete to flow to the inner side of the support structure 10 to reinforce the assembly of the concrete layer 20 and the support panels 12.

In a preferred embodiment, the support structure 10 is made of wood and the frame 14 is a lattice adapted to be easily transported or moved.

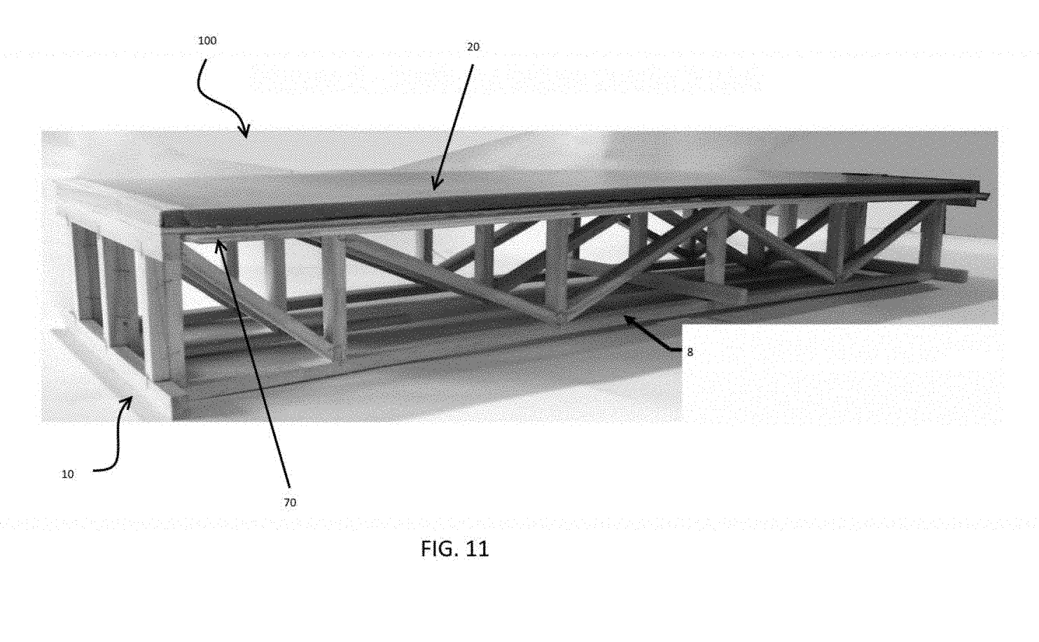

In a another embodiment, the support structure 10 may further comprise a protruding side support 70 (see FIG. 11) acting as an assembling portion adapted to be attached to a complementary portion, such as male and female portions.

Understandably, the support structure may be made of any other material allowing the desired adhesion to the concrete layer.

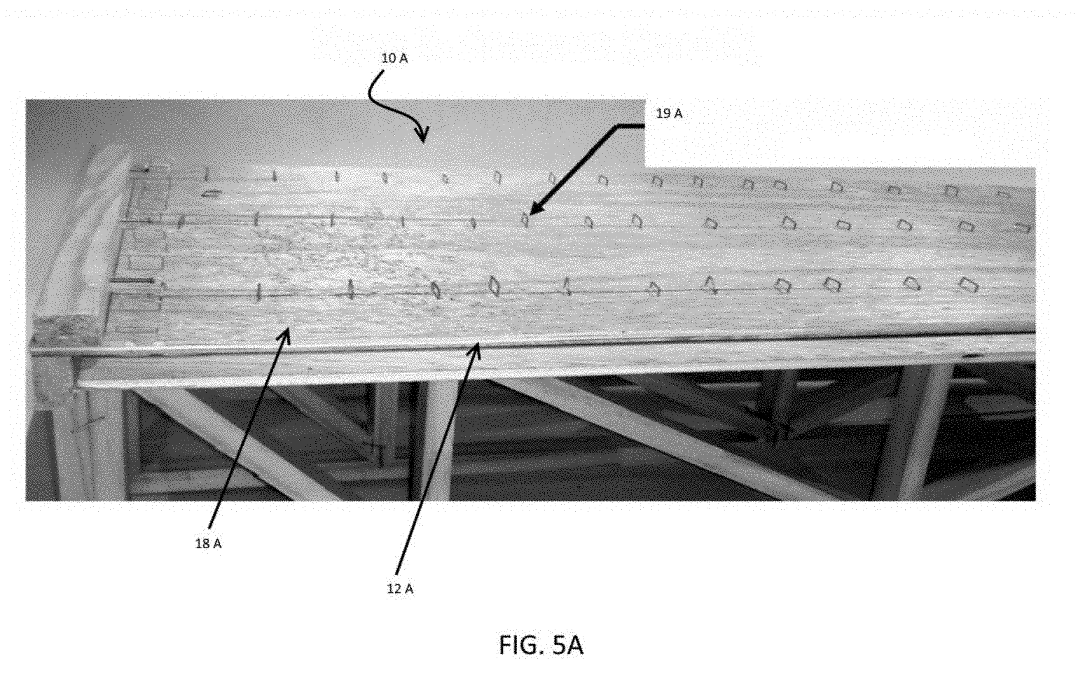

Now referring to FIG. 5, another embodiment of the support structure 10 comprising reinforcing elements 19 is shown. In such an embodiment, the inner portion 9 of the support structure 10 comprises a set of reinforcing elements 19 outwardly angled from the outer surface 18 of the top portion 11. The reinforcing elements 19 are preferably distributed all over the outer surface 18. Such distribution of the reinforcing elements 19 aims at improving the adhesion between the support panels 12 of the support structure 10 and the concrete layer 20.

Now referring to FIG. 5A, a further embodiment of the support structure 10A is shown. In such an embodiment, the support structure 10A may comprise any attachment mean, such reinforcing element 19A acting as attachment mechanism and as retaining the top portion 12A to the support structure 10A. In such an embodiment, the reinforcing elements 19A allows the adhesion of the support panels 12A to the concrete layer. Preferably, the reinforcing elements 19A are distributed all over the outer surface 18A of the top portion of the support structure 10A.

In a preferred embodiment, the prefabricated composite floor aims at providing soundproofing and fire resistance for multi-floor buildings.

In a yet other embodiments, the prefabricated composite floor is configured in a way that any external loading is mainly supported by the support structure 10.

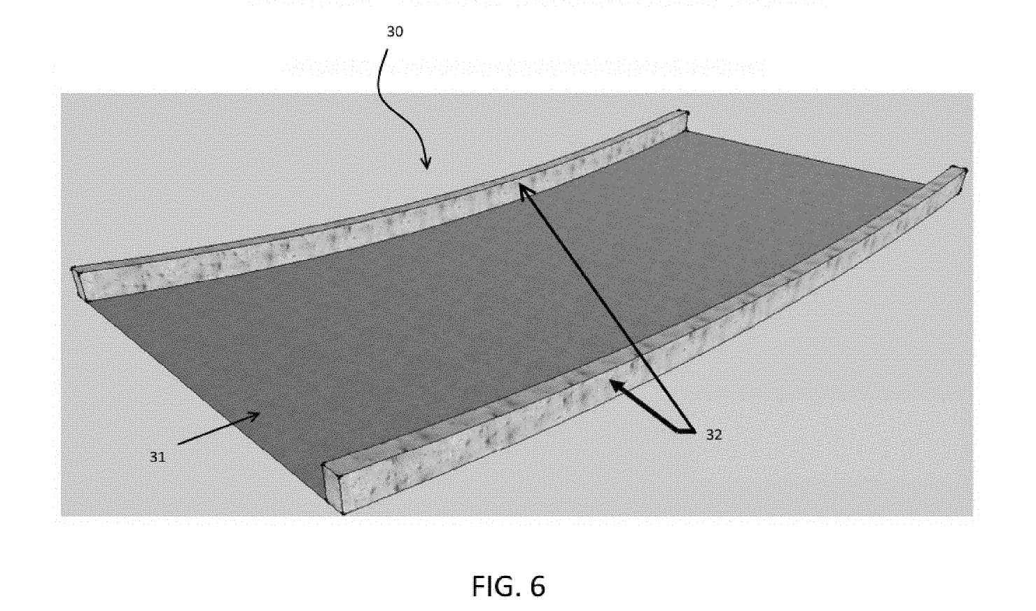

Referring now to FIGS. 6-12, a method for manufacturing a prefabricated wood/concrete composite floor is illustrated. The method comprises the step of pouring concrete in a mould 121. Understandably, as known in the art of moulding, the pouring of the concrete 20 may be of any duration depending on the desired thickness of the concrete slab to be manufactured.

Now referring to FIG. 6, an embodiment of the mould 30 adapted to manufacture a concrete slab is shown. The mould defines the desired shape of the concrete slab to be manufactured. In a preferred embodiment, the mould has a general rectangular shape and defines an arcuate surface 31 limited by parallel edges 32. Understandably, the mould 30 may have any other shape based on the desired shape of the concrete slab to manufacture. The arcuate surface 31 of the mould 30 aims at obtaining a final prefabricated composite floor having a concave concrete layer 20. Such a concave shape generally aims at providing improved mechanical resistance to loads on the prefabricated composite floor.

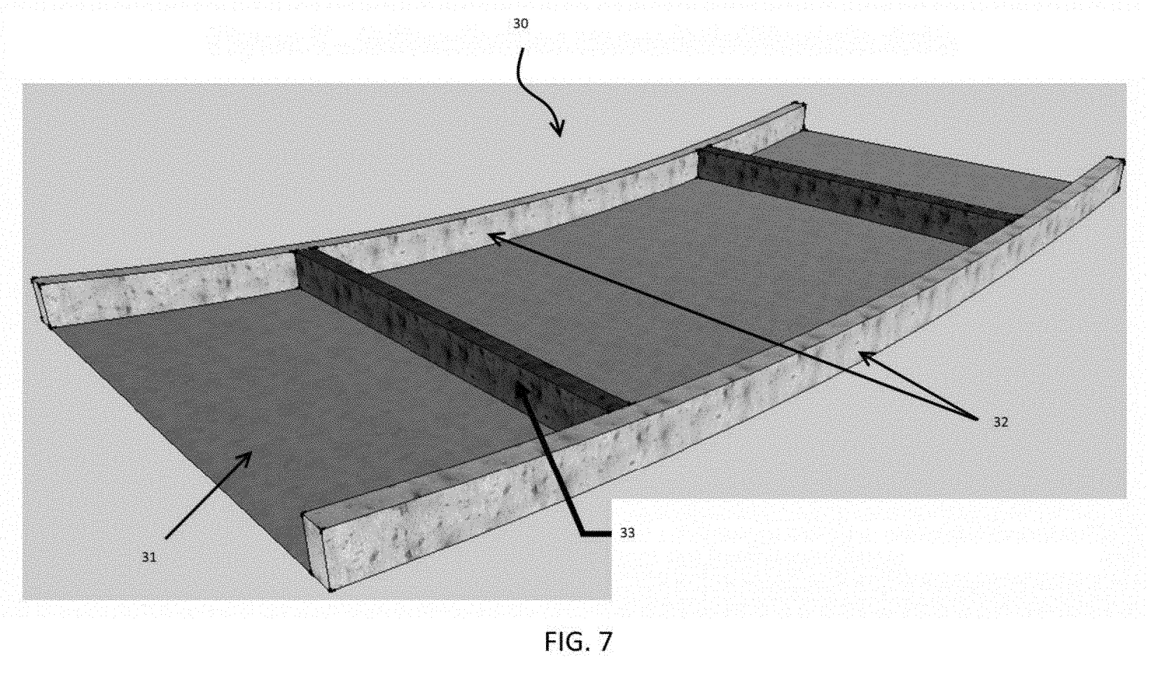

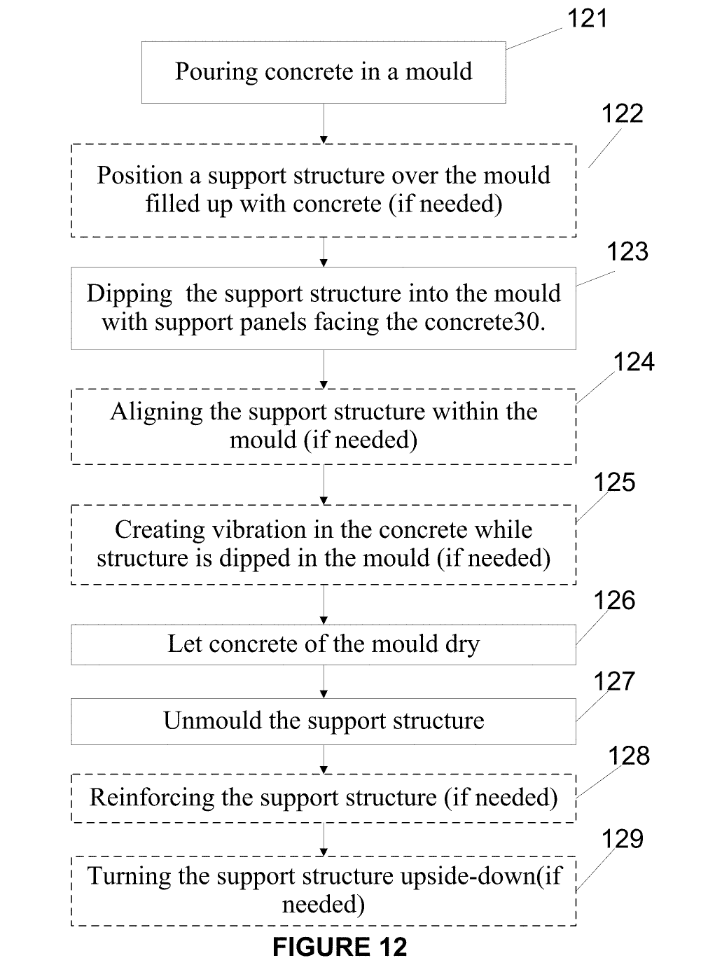

Now referring to FIGS. 7 and 12, another embodiment of the mould 30 is shown. In such an embodiment, the mould 30 may comprise additional structural elements 33 adapted to limit the length of the moulding surface. Such additional structural elements 33 may be movable to adapt to the desired size of the composite floor to be manufactured.

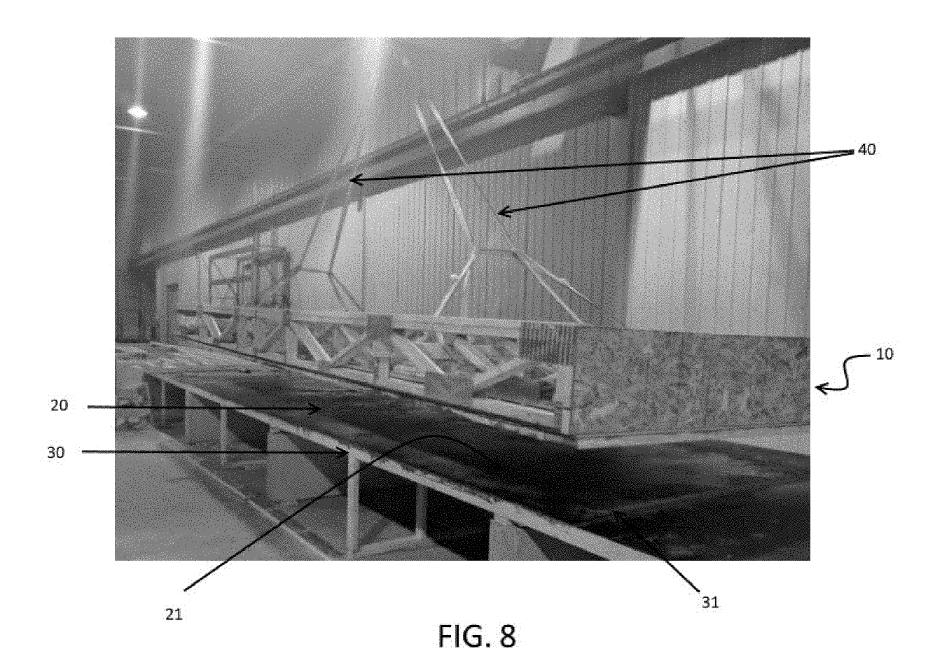

Now referring to FIGS. 8 and 12, the method may further comprise attaching the frame 14 of the support structure 10 to any attachment mean or device 122, such as slings 40 of a positioning system. The attachment to the attachment device generally aims at properly positioning the support structure 10 over the mould 30 filled up with concrete 20.

Now referring to FIG. 12, the method further comprises lowering or at least dipping 123 the support structure 10 into the mould 30 in a way that the support panels 12 are facing the top surface 21 of the concrete 20 within the mould 30. The method may further comprise aligning 124 the support structure 10 with the mould 30, thus ensuring that the top portion 11 is all within the mould 30 containing the concrete 20.

Still referring to FIG. 12, in some embodiments, the method may further comprise using a mechanical vibrator or a vibrating device 125 to adapt the shape of the concrete 20 once the support structure 10 is dipped into the mould 30. Using vibration generally aims at ensuring a good adhesion between the support panels 12 and the concrete 20 and/or ensuring concrete 20 to flow evenly in the openings 13 to provide an anchor.

The method further comprises the step of waiting, for a predetermined time for the concrete to dry 126. In such a step, the surface of the support panels 12 is maintained in the mould 30 until the concrete hardens to attach to the support panels 12.

The method may further comprise unmolding 127 the support structure 10 from the mould 30. The unmolding is preferably done using the positioning system used initially to dispose the support structure 10 over and in the mould 30.

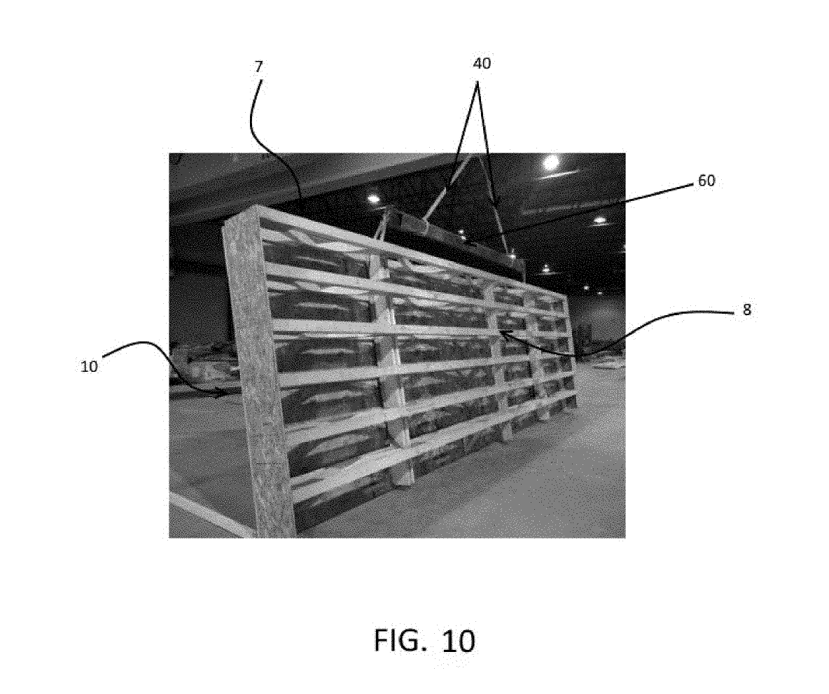

Referring now to FIGS. 10 to 12, the method may further comprise rotating 129 the support structure 10 upside down in a way to render the support structure 10 resting on the bottom side 8 of the frame 14. Preferably, the rotation of the support structure is preceded by reinforcing the support structure 128 or in some embodiments by attaching the attachment device 40 of the positioning system to a reinforcing rod 60. In a preferred embodiment, the reinforcing rod 60 is attached parallel to the side surface 7 of the frame 14. Such attachment generally aims at properly distributing the strength exerted on the frame 14 during the rotation process.

In a preferred embodiment, the method may further comprise introducing the support structure 10 in the mould 30 for support panels 12 to be disposed faced to the top surface 21 of the concrete 20 within the mould 30. Once the top portion 11 of the support structure 10 is being disposed on the top 21 of the concrete layer 20, the weight of the support structure 10 exerts a downward force causing the upward flow of the concrete layer 20 through openings 13 of the support panels 12 towards the inner portion 9 of the support structure 10 (see FIG. 9).

In a preferred embodiment, the method may further comprise using a mechanical vibrator allowing to adjust the shape of the concrete 20 located below the support panels 12 and to control the flow of the concrete 20 over the openings 13 of the support panels 12 in order to release the air particles generally trapped between the support panels 12 and the concrete 20. The vibrations may also aim at ensuring a good adhesion between the support panels 12 and the concrete 20.

In a preferred embodiment, the method may further comprise the step of waiting for a predetermined time for the concrete to dry. In such a step, the concrete flows through the openings 13 of the support panels 12 and the surface of the support panels 12 is maintained in the mould 30 until the concrete hardens to attach to the support panels 12.

In another embodiment, the method may comprise lowering or at least dipping the support structure 10 in the mould 30 in a way that the support panels 12 are facing the top surface 21 of the concrete 20 within the mould 30. The method may further comprise aligning the support structure 10 with the mould 30, thus ensuring that the reinforcing elements are being fully submerged inside the concrete layer 20.

In another embodiment, the method may further comprise the step of waiting for a predetermined time for the concrete to dry. In such a step, the surface of the support panels 12 is maintained in the mould 30 until the concrete hardens to attach to the support panels 12 by the mean of reinforcing elements outwardly angled from the inner surface of the support structure 10 and being fully submerged inside the concrete layer 20.

In yet a preferred embodiment, the method further comprises installing anchor slings to the prefabricated composite floor being made of the support structure rigidly attached to the concrete layer to prepare the composite floor for being transported to the desired destination.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

What is claimed is:

1) A prefabricated composite floor, the prefabricated composite floor comprising:
a concrete layer;
a support structure adapted to receive the concrete layer, the support structure comprising a top portion comprising at least one attachment mechanism, the attachment mechanism being adapted to rigidly adhere the concrete layer to the support structure.

2) The prefabricated composite floor of claim 1, the at least one attachment mean being a reinforcing element, the reinforcing element further attaching the top portion to the support portion.

3) The prefabricated composite floor of claim 2, the reinforcing element being outwardly angled from an outer surface of the top portion.

4) The prefabricated composite floor of claim 1, the at least one attachment mean being one or more openings within the top portion of the support structure, each of the one or more openings being adapted to let concrete flows between an outer surface of the top portion and an inner surface of the top portion.

5) The prefabricated composite floor of claim 1, the top portion comprising support panels being adapted to be rigidly attached to the concrete layer; the support panels being supported by a frame.

6) The prefabricated composite floor of claim 5, the support panels being distributed over the top portion in a way to define slots allowing concrete to flow between into an inner side of the top portion and an outer side of the top portion.

7) The prefabricated composite floor of claim 5, the frame being shaped as a lattice.

8) The prefabricated composite floor of claim 1, the prefabricated composite floor being a concrete/wood composite floor.

9) A method for manufacturing a prefabricated composite floor, the method comprising:
pouring a concrete in a mold;
dipping a top portion of a support structure into the mold, the support structure comprising at least one attachment mechanism adapted to reinforce adherence of the concrete to the top portion of the support structure;
letting the concrete dries for a predetermined duration;
unmolding the support structure from the mould.

10) The method of claim 9, wherein the mold comprises an arcuate surface and is adapted to be manufacture different sizes and shape of the composite floor.

11) The method of claim 9, wherein the method further comprises attaching support panels to a base frame of the support structure.

12) The method of claim 9, wherein the support panels comprise at least one opening.

13) The method of claim 12, the method further comprising anchoring the top portion to the concrete by letting the concrete flows between an inner portion of the top portion and an outer portion of the top portion through the at least one opening.

14) The method of claim 9, wherein the support panels further comprises at least one reinforcing element.

15) The method of claim 13, the method further comprising dipping the support structure into the mould to fully submerge the at least one reinforcing element into concrete.

16) The method of claim 9, the method further comprising generating vibration in the concrete within the mould.

17) The method of claim 9, the method further comprising positioning the support structure over the mould.

18) The method of claim 9, the method further comprising using a positioning mechanism to unmold the support structure.

19) The method of claim 9, the method further comprising turning upside down the unmolded support structure rigidly attached to the concrete layer.

20) The method of claim 19, the method further comprising comprises reinforcing the support structure prior to turning the support structure.
